(19) United States
(12) Patent Application Publication
(10) Pub. No.: US 2019/0089007 A1
(43) Pub. Date: Mar. 21, 2019

(54) AQUEOUS LITHIUM ION SECONDARY BATTERY

(71) Applicant: TOYOTA JIDOSHA KABUSHIKI KAISHA, Toyota-shi (JP)

(72) Inventors: Hiroshi SUYAMA, Mishima-shi (JP); Hideki NAKAYAMA, Susono-shi (JP)

(73) Assignee: TOYOTA JIDOSHA KABUSHIKI KAISHA, Toyota-shi (JP)

(21) Appl. No.: 16/125,844

(22) Filed: Sep. 10, 2018

(30) Foreign Application Priority Data
Sep. 15, 2017 (JP) 2017-178278

(51) Int. Cl. H01M 10/36; H01M 4/485

(52) U.S. Cl. CPC H01M 10/36; H01M 2004/027; H01M 4/485

(57) ABSTRACT

Provided is an aqueous lithium ion secondary battery configured to ensure cycle stability. Disclosed is an aqueous lithium ion secondary battery comprising: an aqueous liquid electrolyte comprising water and an electrolyte, an anode active material layer comprising an anode active material, and an anode current collector, wherein a charge potential of the anode active material calculated from a current value of a reduction peak observed by cyclic voltammetry measurement using the anode active material and the aqueous liquid electrolyte, is a more noble potential than a reduction decomposition potential of the aqueous liquid electrolyte on carbon, and it is a more base potential than the reduction decomposition potential of the aqueous liquid electrolyte on the anode current collector, wherein the anode active material comprises a titanium oxide, and wherein the anode active material comprises a carbon coating layer on a surface thereof.

### TECHNICAL FIELD

The disclosure relates to an aqueous lithium ion secondary battery.

### BACKGROUND

An aqueous liquid electrolyte for a lithium ion battery is known to have a limited electrochemically-stable potential range (potential window).

As a method for solving the problem with the aqueous liquid electrolyte, Non-Patent Literature 1 discloses a highly-concentrated aqueous liquid electrolyte called hydrate melt electrolyte, which is obtained by mixing two kinds of specific lithium salts and water at a given ratio. In Non-Patent Literature 1, it was confirmed that by using such a highly-concentrated aqueous liquid electrolyte, an aqueous lithium ion secondary battery comprising Li₄Ti₅O₁₂ (hereinafter may be referred to as “LTO”) as an anode active material, which is difficult to use as an anode active material in a conventional aqueous lithium ion battery, can be charged and discharged.

Patent Literature 1 discloses an aqueous secondary battery comprising a carbon-containing coating layer on part of the surface of anode active material particles having a NASICON-type crystal structure.
Patent Literature 1: Japanese Patent Application Laid-Open No. 2015-002069
Non-Patent Literature 1: Yuki Yamada et al., “Hydrate-melt electrolytes for high-energy-density aqueous batteries”, NATURE ENERGY (26 Aug. 2016)

In the case of the NASICON-type anode active material described in Patent Literature 1, the charge potential is about 2.5 V (vs. Li/Li⁺) and is within the potential window of the liquid electrolyte. Meanwhile, electrolysis of a common aqueous liquid electrolyte proceeds at a more noble potential than the charge potential of LTO. For the highly-concentrated aqueous liquid electrolyte disclosed in Non-Patent Literature 1, the potential window is extended by addition of lithium bis(trifluoromethanesulfonyl)imide (LiTFSI). However, the electrolysis of the aqueous liquid electrolyte may proceed at a more noble potential than the charge potential of LTO.

The reason is considered as follows. In the case of using such an anode active material (e.g., LTO) that the charge potential is more base than a potential resulting from a reaction between a current collector and an aqueous liquid electrolyte, since the charge potential of the anode active material is not within the potential window of the aqueous liquid electrolyte, the aqueous liquid electrolyte is electrochemically reduced/decomposed at a more noble potential than the charge potential of the anode active material; therefore, current is consumed for the liquid electrolyte reducing/decomposing reaction of the liquid electrolyte, and an anode active material charging reaction does not proceed.

In Non-Patent Literature 1, a highly-concentrated aqueous liquid electrolyte and Al are used as an aqueous liquid electrolyte and an anode current collector, respectively, thereby extending the reduction-side potential window of the aqueous liquid electrolyte and making it possible to charge and discharge an aqueous lithium ion secondary battery comprising LTO as the anode active material. The extension of the reduction-side potential window is considered to be due to the formation of a solid electrolyte interface (hereinafter may be referred to SEI) on the surface of the anode active material, which is derived from the reduction/decomposition of bis(trifluorosulfonyl)imide anions.

However, when the anode active material (e.g., LTO) that the charge potential is more base than the potential resulting from the current collector and the aqueous liquid electrolyte, is used in the aqueous lithium ion secondary battery, the secondary battery has a problem of poor cycle stability, since the SEI formed on the anode active material has insufficient durability.

### SUMMARY

The disclosed embodiments were achieved in light of the above circumstances. An object of the disclosed embodiments is to provide an aqueous lithium ion secondary battery configured to ensure cycle stability.

In a first embodiment, there is provided an aqueous lithium ion secondary battery comprising:

an aqueous liquid electrolyte comprising water and an electrolyte,

an anode active material layer comprising an anode active material, and

an anode current collector,

wherein a charge potential of the anode active material calculated from a current value of a reduction peak observed by cyclic voltammetry measurement using the anode active material and the aqueous liquid electrolyte, is a more noble potential than a reduction decomposition potential of the aqueous liquid electrolyte on carbon, and it is a more base potential than the reduction decomposition potential of the aqueous liquid electrolyte on the anode current collector,

wherein the anode active material comprises a titanium oxide, and

wherein the anode active material comprises a carbon coating layer on a surface thereof.

A pH of the aqueous liquid electrolyte may be 3 or more and 11 or less.

The electrolyte may be lithium bis(trifluoromethanesulfonyl)imide.

The anode current collector may be at least one material selected from the group consisting of Al, Zn, Sn, Ni, SUS and Cu.

The titanium oxide may be at least one compound selected from the group consisting of Li₄Ti₅O₁₂ and TiO₂.

According to the disclosed embodiments, the aqueous lithium ion secondary battery configured to ensure cycle stability can be provided.

### BRIEF DESCRIPTION OF THE DRAWINGS

In the accompanying drawings,

FIG. 1 is a schematic sectional view of an example of the aqueous lithium ion secondary battery according to an embodiment;

FIG. 2 is a graph showing a linear sweep voltammogram of an evaluation cell of Reference Example 1 comprising a carbon plate as a working electrode, and a linear sweep voltammogram of an evaluation cell of Reference Example 2 comprising a SUS316L foil as a working electrode;

FIG. 3 is a graph showing a relationship between the number of CV cycles (≈first to 100th cycles) and the amount of oxidation charge discharge capacity) (mC) for both an evaluation cell of Example 1 comprising a carbon-coated LTO electrode as a working electrode, and an evaluation cell of Comparative Example 1 comprising a LTO electrode as a working electrode;

FIG. 4 shows cyclic voltammograms (first to 100th cycles) of the evaluation cell of Example 1 comprising the carbon-coated LTO electrode as the working electrode; and

FIG. 5 shows cyclic voltammograms (first to 100th cycles) of the evaluation cell of Comparative Example 1 comprising the LTO (non-carbon-coated LTO) electrode as the working electrode.

### DETAILED DESCRIPTION

The aqueous lithium ion secondary battery according to the disclosed embodiments is an aqueous lithium ion secondary battery comprising:

an aqueous liquid electrolyte comprising water and an electrolyte,

an anode active material layer comprising an anode active material, and

an anode current collector,

wherein a charge potential of the anode active material calculated from a current value of a reduction peak observed by cyclic voltammetry measurement using the anode active material and the aqueous liquid electrolyte, is a more noble potential than a reduction decomposition potential of the aqueous liquid electrolyte on carbon, and it is a more base potential than the reduction decomposition potential of the aqueous liquid electrolyte on the anode current collector,

wherein the anode active material comprises a titanium oxide, and

wherein the anode active material comprises a carbon coating layer on a surface thereof.

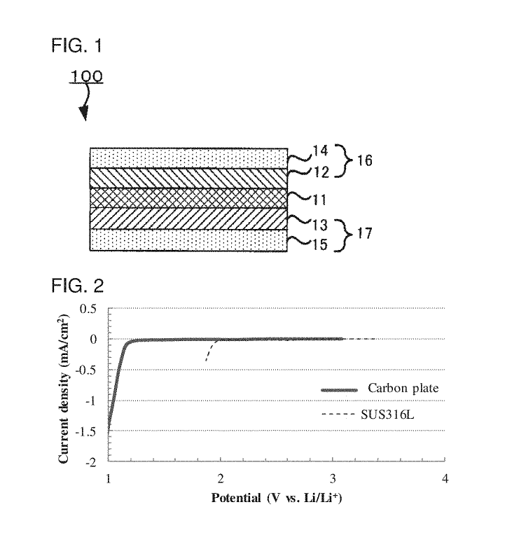

FIG. 1 is a schematic sectional view of an example of the aqueous lithium ion secondary battery according to the disclosed embodiments. An aqueous lithium ion secondary battery 100 according to the disclosed embodiments, comprises a cathode 16 comprising a cathode active material layer 12 and a cathode current collector 14, an anode 17 comprising an anode active material layer 13 and an anode current collector 15, and an aqueous liquid electrolyte 11 disposed between the cathode 16 and the anode 17.

As shown in FIG. 1, the anode 17 is present on one side of the aqueous liquid electrolyte 11, and the cathode is present on the other side of the aqueous liquid electrolyte 11. In the aqueous lithium ion secondary battery, the cathode 16 and the anode 17 are brought into contact with the aqueous liquid electrolyte 11 for use. The aqueous lithium ion secondary battery of the disclosed embodiments is not limited to this example.

In a liquid electrolyte-based lithium ion secondary battery, a liquid electrolyte is present inside an anode active material layer, inside a cathode active material layer, and between the anode active material layer and the cathode active material layer. Therefore, lithium ion conductivity is ensured between the anode active material layer and the cathode active material layer.

In the aqueous lithium ion secondary battery of the disclosed embodiments, a separator may be provided between the anode active material layer and the cathode active material layer, and all of the separator, the anode active material layer and the cathode active material layer may be impregnated with the aqueous liquid electrolyte.

Also in the aqueous lithium ion secondary battery of the disclosed embodiments, the anode active material layer comprises at least the anode active material, and the anode active material comprises a carbon coating layer on a surface thereof.

The aqueous liquid electrolyte may penetrate to the inside of the anode active material layer and the cathode active material layer, and it may be in contact with the anode current collector and the cathode current collector.

### (1) Anode

The anode comprises the anode active material layer and the anode current collector for collection of current from the anode active material layer.

The anode active material layer contains at least an anode active material. As needed, it contains a conductive additive and a binder.

The anode active material may be such an active material that the charge potential of the anode active material calculated from the current value of the reduction peak observed by cyclic voltammetry (CV) measurement using the anode active material and the aqueous liquid electrolyte, is a more noble potential than the reduction decomposition potential of the aqueous liquid electrolyte on carbon, and it is a more base potential than the reduction decomposition potential of the aqueous liquid electrolyte on the anode current collector.

In the disclosed embodiments, the reduction decomposition potential of the aqueous liquid electrolyte on carbon is a potential at which the aqueous liquid electrolyte is reduced/decomposed by contact with carbon, and it is about 1.3 V vs. Li/Li⁺.

Also in the disclosed embodiments, the reduction decomposition potential of the aqueous liquid electrolyte on the anode current collector is a potential at which the aqueous liquid electrolyte is reduced/decomposed by contact with the anode current collector, and the reduction decomposition potential varies depending on the material of the anode current collector. For example, the reduction decomposition potential is about 1.74 V vs. Li/Li⁺ when the anode current collector is Al, about 1.92 V vs. Li/Li⁺ when the anode current collector is Zn, about 1.99 V vs. Li/Li⁺ when the anode current collector is Sn, about 2.36 V vs. Li/Li⁺ when the anode current collector is Ni, about 2.10 V vs. Li/Li⁺ when the anode current collector is SUS, and about 2.24 V vs. Li/Li⁺ when the anode current collector is Cu.

The reduction decomposition potential of the aqueous liquid electrolyte on the anode current collector can be calculated by the following method, for example. First, CV measurement of the anode current collector is carried out using the aqueous liquid electrolyte. Then, on the thus-obtained cyclic voltammogram of the first cycle, the potential of an inflection point just before a reducing-side electrolytic current (faradaic current) flows, which is observed upon potential sweeping in the base potential direction, may be calculated as the reduction decomposition potential of the aqueous liquid electrolyte on the anode current collector. From the viewpoint of lowering a measurement error, the reduction decomposition potential may be calculated under the same condition (e.g., the type of the solvent of the aqueous liquid electrolyte used for the CV measurement (such as water), the type of the electrolyte (such as LiTFSI), the concentration of the electrolyte (such as 21 mol/kg), and the sweep rate in the CV measurement (such as 1 mV/s)). In the CV measurement, the sweep rate is not particularly limited. The upper limit of the sweep rate may be 10 mV/s or less. From the viewpoint of lowering a measurement error, the upper limit may be 1 mV/s or less. The lower limit of the sweep rate may be 0.1 mV/s or more.

Therefore, what is meant by that the charge potential of the anode active material calculated from the current value of the reduction peak observed by cyclic voltammetry (CV) measurement using the anode active material and the aqueous liquid electrolyte, is a more noble potential than the reduction decomposition potential of the aqueous liquid electrolyte on carbon, and it is a more base potential than the reduction decomposition potential of the aqueous liquid electrolyte on the anode current collector, is as follows: the anode active material has a charge potential in such a range that the lower limit is more than 1.3 V vs. Li/Li⁺ and, although the upper limit varies depending on the material for the anode current collector, the upper is less than 1.74 V vs. Li/Li⁺ in the case of Al, for example.

The anode active material used in the disclosed embodiments comprises a titanium oxide.

As the titanium oxide, examples include, but are not limited to, Li₄Ti₅O₁₂ (LTO) and TiO₂.

The charge potential of the LTO calculated from the current value of the reduction peak observed by the CV measurement, is from about 1.5 V vs. Li/Li⁺ to about 1.65 V vs. Li/Li⁺.

The charge potential of the TiO₂ calculated from the current value of the reduction peak observed by the CV measurement, is about 1.6 V vs. Li/Li⁺.

The charge potential of the anode active material can be calculated from the current value of the reduction peak on the cyclic voltammogram of the first cycle obtained by the CV measurement of the anode active material carried out at a sweep rate of 1 mV/s using the aqueous liquid electrolyte, for example.

More specifically, on the cyclic voltammogram, the potential of the inflection point just before the reduction-side electrolytic current (faradaic current) flows, which is measured upon potential sweeping at a sweep rate of 1 mV/s in the base potential direction (that is, the potential just before the reduction peak appears) may be determined as the charge potential (the reduction-side potential) of the anode active material. From the viewpoint of lowering a measurement error, the charge potential of the anode active material may be calculated under the same condition (e.g., the type of the solvent of the aqueous liquid electrolyte used for the CV measurement (such as water), the type of the electrolyte (such as LiTFSI), the concentration of the electrolyte (such as 21 mol/kg), and the sweep rate in the CV measurement (such as 1 mV/s)). The sweep rate in the CV measurement can be the same as the rate described in the method for calculating the reduction decomposition potential described above. The type of the contained solvent, the type of the electrolyte, and the type of other component may be the same or different between the aqueous liquid electrolyte used for the calculation of the charge potential of the anode active material and the aqueous liquid electrolyte used in the aqueous lithium ion secondary battery of the disclosed embodiments. They may be the same between the aqueous liquid electrolytes. Also, the concentration of the electrolyte, the concentration of other component, and the pH of the aqueous liquid electrolyte may be the same or different between the aqueous liquid electrolytes. They may be the same between the aqueous liquid electrolytes.

Meanwhile, in the disclosed embodiments, the discharge potential of the anode active material is a potential calculated from the current value of an oxidation peak observed by the CV measurement using the anode active material and the aqueous liquid electrolyte.

For example, the discharge potential of the anode active material can be calculated from the current value of the oxidation peak on the cyclic voltammogram of the first cycle obtained by the CV measurement of the anode active material carried out at a sweep rate of 1 mV/s using the aqueous liquid electrolyte.

More specifically, on the cyclic voltammogram, the potential of the inflection point just before the oxidation-side electrolytic current (faradaic current) flows, which is observed upon potential sweeping at a sweep rate of 1 mV/s in the noble potential direction (that is, the potential just before the oxidation peak appears) may be determined as the discharge potential (the oxidation-side potential) of the anode active material.

Also in the disclosed embodiments, the charge-discharge potential is the average of the charge potential and the discharge potential.

For the CV measurement, a potentiostat, a potentio-galvanostat or the like can be used.

The anode active material used in the disclosed embodiments comprises a carbon coating layer on a surface thereof.

If the anode active material is used as it is in the battery, without providing the carbon coating layer on the surface thereof, and if the charge potential of the anode active material is outside the potential window of the aqueous liquid electrolyte, the reduction/decomposition of the aqueous liquid electrolyte proceeds at a more noble potential than the charge potential of the anode active material. Therefore, the battery cannot be charged and discharged.

Meanwhile, by providing, on the surface of the anode active material, the carbon coating layer that is not reactive with the aqueous liquid electrolyte at a more noble potential than the charge potential of the anode active material, the reduction/decomposition of the aqueous liquid electrolyte on the anode active material surface can be inhibited. As a result, the cycle characteristics of the battery can be increased.

The carbon material used for the carbon coating is not particularly limited and may be a conventionally known material.

The method of carbon coating is not particularly limited. For example, the carbon coating may be carried out by printing (e.g., gravure printing) using electroconductive particulate carbon. Also, the carbon coating may be carried out by deposition such as chemical vapor deposition (CVD) and physical vapor deposition (PVD) or by sputtering.

The thickness of the carbon coating layer may be 5 μm or less, or it may be about 1 μm.

The carbon coating layer may coat at least part of the surface of the anode active material, as long as it can inhibit the reduction/decomposition of the aqueous liquid electrolyte on the anode active material surface due to contact between the anode active material and the aqueous liquid electrolyte. From the viewpoint of inhibiting the aqueous liquid electrolyte from permeating into the anode active material, the carbon coating layer may coat the whole surface of the anode active material. As long as the carbon coating layer coats at least part of the surface of the anode active material, it may coat the whole surface of the anode active material layer. When the carbon coating layer coats the whole surface of the anode active material layer, the anode active material layer may contain a conductive additive and a binder, in addition to the anode active material, or the anode active material layer may be composed of the anode active material only.

When the aqueous lithium ion secondary battery of the disclosed embodiments has such a structure that the battery casing is filled with the aqueous liquid electrolyte and the whole surface of the anode active material layer is in contact with the aqueous liquid electrolyte, the anode active material layer may comprise the carbon coating layer on the whole surface thereof.

On the other hand, when the aqueous lithium ion secondary battery of the disclosed embodiments has such a structure that a separator is impregnated with the aqueous liquid electrolyte and is in contact with the anode active material layer, the carbon coating layer may be formed on at least a surface of the anode active material layer, which is in contact with the separator, or the carbon coating layer may coat the whole surface of the anode active material layer.

The presence of the carbon coating layer may be checked by CV or energy dispersive X-ray analysis (EDX).

The form of the anode active material is not particularly limited. For example, it may be a particulate form, from the viewpoint of increasing the surface area to obtain increased reactivity, and from the viewpoint of easily coating the surface with carbon. When the anode active material is in a particulate form, the primary particle diameter of the anode active material may be 1 nm or more and 100 μm or less. The lower limit of the primary particle diameter may be 10 nm or more, 50 nm or more, or 100 nm or more. The upper limit of the primary particle diameter may be 30 μm or less, or it may be 10 μm or less. The primary particles of the anode active material may aggregate to form secondary particles. In this case, the particle diameter of the secondary particles is not particularly limited and is generally 0.5 μm or more and 100 μm or less. The lower limit of the particle diameter may be 1 μm or more, and the upper limit of the particle diameter may be 20 μm or less. When the particle diameter of the anode active material is in such a range, the anode active material layer can obtain excellent ion conductivity and electron conductivity.

In the disclosed embodiments, the average particle diameter of the particles is calculated by a general method. An example of the method for calculating the average particle diameter of the particles, is as follows. First, for a particle shown in an image taken at an appropriate magnitude (e.g., 50,000× to 1,000,000×) with a transmission electron microscope (hereinafter referred to as TEM) or a scanning electron microscope (hereinafter referred to as SEM), the diameter is calculated on the assumption that the particle is spherical. Such a particle diameter calculation by TEM or SEM observation is carried out on 200 to 300 particles of the same type, and the average of the particles is determined as the average particle diameter.

The amount of the anode active material contained in the anode active material layer is not particularly limited. For example, when the whole anode active material layer is determined as a reference (100 mass %), the anode active material may be 10 mass % or more, may be 20 mass % or more, or may be 40 mass % or more. The upper limit of the amount is not particularly limited. It may be 100 mass % or less, may be 95 mass % or less, or may be 90 mass % or less. When the content of the anode active material is in such a range, the anode active material layer can obtain excellent ion conductivity and electron conductivity.

The conductive additive can be selected from conductive additives that are generally used in aqueous lithium ion secondary batteries. In particular, the conductive additive may be a conductive additive that contains a carbonaceous material selected from the group consisting of Ketjen Black (KB), vapor-grown carbon fiber (VGCF), acetylene black (AB), carbon nanotube (CNT) and carbon nanofiber (CNF).

Also, a metal material that is able to withstand battery usage environments, may be used.

The conductive additive may be one kind of conductive additive or may be a combination of two or more kinds of conductive additives.

The form of the conductive additive may be selected from various kinds of forms such as a powdery form and a fiber form.

The amount of the conductive additive contained in the anode active material layer is not particularly limited. For example, when the whole anode active material layer is determined as a reference (100 mass %), the conductive additive may be 1 mass % or more, may be 3 mass % or more, or may be 10 mass % or more. The upper limit of the amount is not particularly limited. It may be 90 mass % or less, may be 70 mass % or less, or may be 60 mass % or less. When the content of the conductive additive is in such a range, the anode active material layer can obtain excellent ion conductivity and electron conductivity.

The binder can be selected from binders that are generally used in aqueous lithium ion secondary batteries. As the binder, examples include, but are not limited to, styrene-butadiene rubber (SBR), carboxymethyl cellulose (CMC), acrylonitrile-butadiene rubber (ABR), butadiene rubber (BR), polyvinylidene fluoride (PVDF) and polytetrafluoroethylene (PTFE).

The binder may be one kind of binder or may be a combination of two or more kinds of binders.

The amount of the binder contained in the anode active material layer is not particularly limited. For example, when the whole anode active material layer is determined as a reference (100 mass %), the binder may be 1 mass % or more, may be 3 mass % or more, or may be 5 mass % or more. The upper limit of the amount is not particularly limited. It may be 90 mass % or less, may be 70 mass % or less, or may be 50 mass % or less. When the content of the binder is in such a range, the anode active material and so on can appropriately bind to each other, and the anode active material layer can obtain excellent ion conductivity and electron conductivity.

The thickness of the anode active material layer is not particularly limited. For example, it may be 0.1 μm or more and 1 mm or less, or it may be 1 μm or more and 100 μm or less.

For the aqueous lithium ion secondary battery of the disclosed embodiments, the material for the anode current collector may be at least one kind of metal material selected from the group consisting of Al, Zn, Sn, Ni, SUS and Cu. As long as the surface of the anode current collector is composed of the metal material, the inside of the anode current collector may be composed of a material that is different from the surface.

As the form of the anode current collector, examples include, but are not limited to, a foil form, a plate form, a mesh form, a perforated metal form and a foam form.

### (2) Cathode

The cathode comprises at least a cathode active material layer. As needed, it further comprises a cathode current collector.

The cathode active material layer contains at last a cathode active material. As needed, it contains a conductive additive and a binder.

The cathode active material may be selected from conventionally known materials. The cathode active material has a higher potential than the anode active material and is appropriately selected considering the potential window of the aqueous liquid electrolyte described below. For example, the cathode active material may be a material containing a Li element. More specifically, the cathode active material may be an oxide or polyanion containing a Li element. As the cathode active material, examples include, but are not limited to, lithium cobaltate (LiCoO₂); lithium nickelate (LiNiO₂); lithium manganate (LiMn₂O₄); LiNi_{1/3}Mn_{1/3}Co_{1/3}O₂; a different element-substituted Li—Mn spinel represented by Li₁₊ₓMn_{2-x-y}M_{y}O₄ (where M is one or more selected from Al, Mg, Co, Fe, Ni and Zn); a lithium titanate (LiₓTiO_{y}) that the charge-discharge potential is a more noble potential than the anode active material; and lithium metal phosphate (LiMPO₄ where M is one or more selected from Fe, Mn, Co and Ni). The cathode active material may be LiMn₂O₄ (LMO). The cathode active material may be one kind of cathode active material or a combination of two or more kinds of cathode active materials.

The form of the cathode active material is not particularly limited. As the form, examples include, but are not limited to, a particulate form and a plate form. When the cathode active material is in a particulate form, the primary particle diameter of the cathode active material may be 1 nm or more and 100 μm or less. The lower limit of the primary particle diameter may be 5 nm or more, may be 10 nm or more, or may be 50 nm or more. The upper limit of the primary particle diameter may be 30 μm or less, or it may be 10 μm or less.

The primary particles of the cathode active material may aggregate to form secondary particles. In this case, the particle diameter of the secondary particles is not particularly limited, and it is generally 0.5 μm or more and 50 μm or less. The lower limit of the particle diameter may be 1 μm or more, and the upper limit of the particle diameter may be 20 μm or less. When the particle diameter of the cathode active material is in such a range, the cathode active material layer can obtain excellent ion conductivity and electron conductivity.

The amount of the cathode active material contained in the cathode active material layer is not particularly limited. For example, when the whole cathode active material layer is determined as a reference (100 mass %), the cathode active material may be 10 mass % or more, may be 20 mass % or more, or may be 40 mass % or more. The upper limit of the amount is not particularly limited. It may be 99 mass % or less, may be 97 mass % or less, or may be 95 mass % or less. When the content of the cathode active material is in such a range, the cathode active material layer can obtain excellent ion conductivity and electron conductivity.

The types of the conductive additive and binder contained in the cathode active material layer are not particularly limited. For example, they can be appropriately selected from those exemplified above as the conductive additive and binder contained in the anode active material layer.

The amount of the conductive additive contained in the cathode active material layer is not particularly limited. For example, when the whole cathode active material layer is determined as a reference (100 mass %), the conductive additive may be 0.1 mass % or more, may be 0.5 mass % or more, or may be 1 mass % or more. The upper limit of the amount is not particularly limited. It may be 50 mass % or less, may be 30 mass % or less, or may be 10 mass % or less.

The amount of the binder contained in the cathode active material layer is not particularly limited. For example, when the whole cathode active material layer is determined as a reference (100 mass %), the binder may be 0.1 mass % or more, may be 0.5 mass % or more, or may be 1 mass % or more. The upper limit of the amount is not particularly limited. It may be 50 mass % or less, may be 30 mass % or less, or may be 10 mass % or less. When the amounts of the conductive additive and the binder are in such ranges, the cathode active material layer can obtain excellent ion conductivity and electron conductivity.

The thickness of the cathode active material layer is not particularly limited. For example, it may be 0.1 μm or more and 1 mm or less, or it may be 1 μm or more and 100 μm or less.

The cathode current collector functions to collect current from the cathode active material layer. As the material for the cathode current collector, examples include, but are not limited to, a metal material containing at least one element selected from the group consisting of Ni, Al, Au, Pt, Fe, Ti, Co and Cr. As long as the surface of the cathode current collector is composed of the material, the inside of the cathode current collector may be composed of a material that is different from the surface.

As the form of the cathode current collector, examples include, but are not limited to, a foil form, a plate form, a mesh form and a perforated metal form.

The cathode may further comprise a cathode lead connected to the cathode current collector.

### (3) Aqueous Liquid Electrolyte

The solvent of the aqueous liquid electrolyte contains water as a main component. That is, the whole amount of the solvent (a liquid component) constituting the liquid electrolyte is determined as a reference (100 mol %), the water may account for 50 mol % or more, 70 mol % or more, or 90 mol % or more. On the other hand, the upper limit of the proportion of the water in the solvent is not particularly limited.

Although the solvent contains water as the main component, it may contain a solvent other than water. As the solvent other than water, examples include, but are not limited to, one or more selected from the group consisting of ethers, carbonates, nitriles, alcohols, ketones, amines, amides, sulfur compounds and hydrocarbons. When the whole amount of the solvent (the liquid component) constituting the liquid electrolyte is determined as a reference (100 mol %), the solvent other than water may be 50 mol % or less, may be 30 mol % or less, or may be 10 mol % or less.

The aqueous liquid electrolyte used in the disclosed embodiments contains an electrolyte. The electrolyte for the aqueous liquid electrolyte may be selected from conventionally known electrolytes. As the electrolyte, examples include, but are not limited to, lithium salt, nitrate salt, acetate salt and sulfate salt of imidic acid compounds. More specifically, examples include, but are not limited to, lithium bis(fluorosulfonyl)imide (LiFSI) (CAS No. 171611-11-3), lithium bis(trifluoromethanesulfonyl)imide (LiTFSI) (CAS No. 90076-65-6), lithium bis(pentafluoroethanesulfonyl)imide (LiBETI) (CAS No. 132843-44-8), lithium bis(nonafluorobutanesulfonyl)imide (CAS No. 119229-99-1), lithium nonafluoro-N-[(trifluoromethane) sulfonyl]butanesulfonylamide (CAS No. 176719-70-3), lithium N,N-hexafluoro-1,3-disulfonylimide (CAS No. 189217-62-7), CH₃COOLi, LiPF₆, LiBF₄, Li₂SO₄ and LiNO₃. The electrolyte for the aqueous liquid electrolyte may be LiTFSI.

The concentration of the electrolyte in the aqueous liquid electrolyte can be appropriately determined depending on the properties of the desired battery, as long as the concentration does not exceed the saturation concentration of the electrolyte with respect to the solvent. This is because, when the electrolyte remains in a solid form in water, the solid electrolyte may interfere with battery reaction.

In general, as the concentration of the electrolyte in the aqueous liquid electrolyte increases, the potential window of the aqueous liquid electrolyte extends. However, since the viscosity of the solution increases, the Li ion conductivity of the aqueous liquid electrolyte tends to decrease. Therefore, in general, considering potential window expanding effects and Li ion conductivity, the concentration is determined depending on the properties of the desired battery.

For example, in the case of using LiTFSI as the electrolyte, the amount of the LiTFSI contained in the aqueous liquid electrolyte may be 1 mol or more, 5 mol or more, or 7.5 mol or more per kg of the water. The upper limit of the amount is not particularly limited, and it may be 25 mol or less, for example. In the aqueous liquid electrolyte, as the concentration of the LiTFSI increases, the reduction-side potential window of the aqueous liquid electrolyte tends to extend.

The potential window of the aqueous liquid electrolyte used in the disclosed embodiments varies depending on the material for the electrolyte used, the concentration of the electrolyte, the material for the current collector, etc. For example, in the case of using LiTFSI as the electrolyte, the potential window is from about 1.93 V vs. Li/Li⁺ to about 4.94 V vs. Li/Li⁺.

In addition to the solvent and the electrolyte, the aqueous liquid electrolyte may contain other component. For example, as cation, an alkaline metal other than lithium, an alkaline-earth metal or the like can be added to the aqueous liquid electrolyte. In particular, from the viewpoint of inhibiting decomposition of the liquid electrolyte, the aqueous liquid electrolyte may contain disodium dihydrogen pyrophosphate (Na₂H₂P₂O₇) (CAS No. 7758-16-9), for example. The concentration of the disodium dihydrogen pyrophosphate in the aqueous liquid electrolyte is not particularly limited and may be in a saturated state.

To control the pH of the aqueous liquid electrolyte, for example, lithium hydroxide may be contained in the aqueous liquid electrolyte.

The pH of the aqueous liquid electrolyte is not particularly limited. The pH may be 3 or more, or it may be 6 or more, from the viewpoint of inhibiting reduction/decomposition of the water in the aqueous liquid electrolyte by setting the reduction-side potential window of the aqueous liquid electrolyte to 1.83 V vs. Li/Li⁺ or less, which is said to be the thermodynamically stable range of water.

The upper limit of the pH is not particularly limited. From the viewpoint of keeping the oxidation-side potential window high, the pH may be 11 or less, or it may be 8 or less.

### (4) Other Members

In the aqueous lithium ion secondary battery of the disclosed embodiments, a separator may be provided between the anode active material layer and the cathode active material layer. The separator functions to prevent contact between the cathode and the anode and to form an electrolyte layer by retaining the aqueous liquid electrolyte.

The separator may be a separator that is generally used in aqueous liquid electrolyte batteries (e.g., NiMH, Zu-Air). As the separator, examples include, but are not limited to, cellulose-based nonwoven fabric and resins such as polyethylene (PE), polypropylene (PP), polyester and polyamide.

The thickness of the separator is not particularly limited. For example, a separator having a thickness of 5 μm or more and 1 mm or less can be used.

As needed, the aqueous lithium ion secondary battery of the disclosed embodiments comprises an outer casing (battery casing) for housing the cathode, the anode and the aqueous liquid electrolyte.

The form of the outer casing is not particularly limited. As the form, examples include, but are not limited to, a laminate form.

The material for the outer casing is not particularly limited, as long as it is stable in electrolyte. As the material, examples include, but are not limited to, resins such as polypropylene, polyethylene and acrylic resin.

The aqueous lithium ion secondary battery of the disclosed embodiments can be produced by employing a known method. For example, it can be produced as follows. However, the method for producing the aqueous lithium ion secondary battery of the disclosed embodiments is not limited to the following method.

(1) The surface of the anode active material is coated with carbon to form a carbon coating layer. Then, the anode active material for forming the anode active material layer, the material comprising the carbon coating layer on the surface thereof, etc., are dispersed in a solvent to obtain a slurry for the anode active material layer. The solvent used here is not particularly limited. As the solvent, examples include, but are not limited to, water and various kinds of organic solvents. Using a doctor blade or the like, the slurry for the anode active material layer is applied to a surface of the anode current collector. The applied slurry is dried to form the anode active material layer on the surface of the anode current collector, thereby obtaining the anode.

(2) The cathode active material for forming the cathode active material layer, etc., are dispersed in a solvent to obtain a slurry for the cathode active material layer. The solvent used here is not particularly limited. As the solvent, examples include, but are not limited to, water and various kinds of organic solvents. Using a doctor blade or the like, the slurry for the cathode active material layer is applied to a surface of the cathode current collector. The applied slurry is dried to form the cathode active material layer on the surface of the cathode current collector, thereby obtaining the cathode.

(3) The separator is sandwiched between the anode and the cathode to obtain a stack of the anode current collector, the anode active material layer, the separator, the cathode active material layer and the cathode current collector, which are stacked in this order. As needed, other members such as a terminal are attached to the stack.

(4) The stack is housed in the battery casing, and the battery casing is filled with the aqueous liquid electrolyte. The battery casing containing the stack and the aqueous liquid electrolyte is hermetically closed so that the stack is immersed in the aqueous liquid electrolyte, thereby obtaining the aqueous lithium ion secondary battery.

### EXAMPLES

### [Preparation of Carbon-Coated Anode Active Material]

LTO was added to saccharose at a mass ratio of the LTO to the saccharose of 2:1. They were mixed by a mortar. Then, the mixture was transferred to a tubular furnace in an Ar atmosphere and fired at 600° C. for two hours to coat the LTO surface with carbon, thereby obtaining a carbon-coated LTO.

### Reference Examples 1 and 2

### 1. Potential Window Evaluation

### 1.1. Preparation of Aqueous Liquid Electrolyte

An aqueous liquid electrolyte was prepared by mixing LiTFSI and water so that the content of LiTFSI was 21 mol per kg of water.

Then, the aqueous liquid electrolyte was left in a thermostat bath at 30° C. overnight. Then, Na₂H₂P₂O₇ was added to the aqueous liquid electrolyte so shat the Na₂H₂P₂O₇was 1 mass %. Again, the aqueous liquid electrolyte was left in the thermostat bath at 30° C. overnight. Then, using the thermostat bath at 25° C., the temperature of the aqueous liquid electrolyte was stabilized at least three hours before evaluation.

### 1.2. Production of Evaluation Cell

As a working electrode, a carbon plate (manufactured by The Nilaco Corporation) and a SUS316L foil (manufactured by The Nilaco Corporation) were used in Reference Examples 1 and 2, respectively. As a counter electrode, a SUS plate coated with Au by vapor deposition (the spacer of a coin battery) was used in both of Reference Examples 1 and 2. The working and counter electrodes were attached to a ring having an aperture size of 10 mm so as to face each other (the distance between the electrodes: about 9 mm).

As a reference electrode, Ag/AgCl (manufactured by International Chemistry Co., Ltd.) was used. A liquid electrolyte (about 2 cc) was injected into a space thus formed between the electrodes, thereby producing an evaluation cell. Reference Examples 1 and 2 are different in the type of the injected liquid electrolyte.

### 1.3. Evaluation Condition

The following devices and condition were used for evaluation.

### (Devices)

Electrochemical measurement device: Multi-channel potentiostat/galvanostat (model: VMP3, manufactured by: Bio-Logic SAS)

Thermostat bath: LU-124 (product name, manufactured by Espec Corp.)

### (Condition)

Linear sweep voltammetry (LSV) at 1 mV/s

### [Lsv Measurement]

Potential sweeping was started from the open circuit potential (OCP) (about 3.2 V vs. Li/Li⁺) to the base potential side (cathode side) and stopped at a potential of −1.7 V vs. Ag/AgCl (about 1.5 V vs. Li/Li⁺) or a lower potential at which reduction-side electrolytic current (faradaic current) continuously flows.

FIG. 2 is a graph showing a linear sweep voltammogram of the evaluation cell of Reference Example 1 comprising the carbon plate as the working electrode and a linear sweep voltammogram of the evaluation cell of Reference Example 2 comprising the SUS316L foil as the working electrode.

### 1.4. Evaluation Results

As shown in FIG. 2, in the case of the evaluation cell of Reference Example 1 comprising the carbon plate as the working electrode, it is clear that reduction current (current produced upon the decomposition of water) is observed at around 1.3 V vs. Li/Li⁺.

In the case of the evaluation cell of Reference Example 2 comprising the SUS foil as the working electrode, it is clear that reduction current (current produced upon the decomposition of water) is observed at around 2.0 V vs. Li/Li⁺.

Therefore, as shown in FIG. 2, it is clear that water can be stably present on carbon until, compared to SUS, a very base potential is reached.

### Example 1 and Comparative Example 1

### 2. Charge-Discharge Evaluation

### 2.1. Preparation of Aqueous Liquid Electrolyte

An aqueous liquid electrolyte was prepared in the same manner as the above-mentioned “1.1. Preparation of aqueous liquid electrolyte”, except that the content of LiTFSI was 18 mol per kg of water.

### 2.2. Coating of Electrodes

In a working electrode (anode), the carbon-coated Li₄Ti₅O₁₂ (LTO) prepared in the above-mentioned “Preparation of carbon-coated anode active material” and LTO were used in Example 1 and Comparative Example 1, respectively, as an anode active material. In a counter electrode (cathode), LiMn₂O₄ (LMO) was used in both Example 1 and Comparative Example 1 as a cathode active material.

As a conductive additive, acetylene black (product name: HS-100, manufactured by: Hitachi Chemical Co., Ltd.) was used. As a binder, PVdF (product name: 9305, manufactured by: Kureha Corporation) was used.

As anode and cathode current collectors, a SUS316L foil was used.

As a cathode current collector, a SUS316L foil (manufactured by The Nilaco Corporation) was used in all of Example 1, Comparative Example 1 and Comparative Example 2.

First, the active material and the conductive additive were mixed by a mortar. Then, the PVdF was added thereto. The active material, the conductive additive and the PVdF were at a mass ratio of 85:10:5. With checking the viscosity of the mixture, NMP was added thereto. They were kept mixed by the mortar until the mixture became a uniform mixture. Then, the uniform mixture was transferred to an ointment container and mixed by the rotation-revolution mixer (product name: Thinky Mixer, manufactured by: Thinky Corporation) at 3000 rpm for 10 minutes, thereby obtaining a slurry. The slurry was placed on a metal foil and applied thereto by the doctor blade. Then, the resulting product was left in a dryer at 60° C. overnight to dry the solvent, thereby obtaining an electrode. The electrode was cut into the form of a circle having a diameter of 16 mm and subjected to roll pressing so as to have a voidage of 40%. The capacity of the LTO electrode was 0.3 mAh/cm², and that of the LMO electrode was 0.6 mAh/cm².

### 2.3. Production of LTO Evaluation Cell

As the working electrode (anode), the carbon-coated LTO electrode and the LTO electrode were used in Example 1 and Comparative Example 1, respectively. As the counter electrode (cathode), the LMO electrode was used in both Example 1 and Comparative Example 1. The working and counter electrodes of Example 1 were attached to a ring having an aperture size of 10 mm so as to face each other (the distance between the electrodes: about 9 mm). As a reference electrode, Ag/AgCl (manufactured by International Chemistry Co., Ltd.) was used. The aqueous liquid electrolyte prepared above (about 2 cc) was injected into a space thus formed between the electrodes, thereby producing the evaluation cell of Example 1. In the same manner as Example 1, the evaluation cell of Comparative Example 1 was produced.

### 2.4. Evaluation Conditions

The following devices and condition were used for evaluation.

### (Devices)

Electrochemical measurement device: Multi-channel potentiostat/galvanostat (model: VMP3, manufactured by: Bio Logic SAS)

Thermostat bath: LU-124 (product name, manufactured by: Espec Corp.)

### (Condition)

As a pretreatment, in LSV, potential sweeping was carried out to −1.0 V vs. Ag/AgCl (about 2.2 V vs. Li/Li⁺) at a sweep rate of 1 mV/s, and then potential holding was carried out at the same potential for one hour.

Then, in CV, potential sweeping was carried out at a sweep rate of 10 mV/s from the open circuit potential (OCP) to the base potential side, and reversed at −1.6 V vs. Ag/AgCl (about 1.6 V vs. Li/Li⁺). Then, at the same sweep rate, potential sweeping was carried out to 0 V vs. Ag/AgCl (about 3.2 V vs. Li/Li⁺). This CV cycle was determined as one cycle, and 100 cycles were carried out.

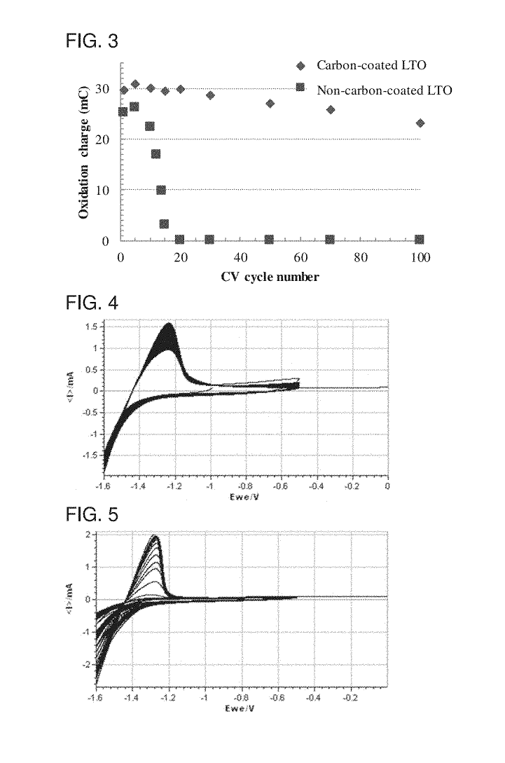

FIG. 3 is a graph showing a relationship between the number of CV cycles (first to 100th cycles) and the amount of oxidation charge (≈discharge capacity) (mC) for both the evaluation cell of Example 1 comprising the carbon-coated LTO electrode as the working electrode and the evaluation cell of Comparative Example 1 comprising the LTO (non-carbon-coated LTO) electrode as the working electrode.

FIG. 4 shows cyclic voltammograms (first to 100th cycles) of the evaluation cell of Example 1 comprising the carbon-coated LTO electrode as the working electrode.

FIG. 5 shows cyclic voltammograms (first to 100th cycles) of the evaluation cell of Comparative Example 1 comprising the LTO (non-carbon-coated LTO) electrode as the working electrode.

From FIGS. 4 and 5, the cycle stability of the evaluation cells can be evaluated.

### 2.5. Evaluation Results

As shown in FIG. 3, for the evaluation cell of Comparative Example 1 comprising the non-carbon-coated LTO electrode as the working electrode, it is clear that after more than 10 charge-discharge cycles, the capacity retention rate of the battery is lower than 50%.

Meanwhile, for the evaluation cell of Example 1 comprising the carbon-coated LTO electrode as the working electrode, it is clear that even after 100 charge-discharge cycles, the capacity retention rate of the battery can be kept at 80% or more. This is presumed to be because decomposition of the aqueous liquid electrolyte caused on the anode active material surface is inhibited by the carbon coating. Also, this is presumed to be because, due to modification made by the carbon coating to a SEI formed on the anode active material surface, the electrical resistance of the anode active material to the aqueous liquid electrolyte was increased.

The aqueous lithium ion secondary battery of the disclosed embodiments is excellent in cycle stability and is applicable to a wide range of power sources from an on-board, large-sized power source for vehicles to a small-sized power source for portable devices.

### REFERENCE SIGNS LIST

11. Aqueous liquid electrolyte
12. Cathode active material layer
13. Anode active material layer
14. Cathode current collector
15. Anode current collector
16. Cathode
17. Anode
100. Aqueous lithium ion secondary battery.

1. An aqueous lithium ion secondary battery comprising:
an aqueous liquid electrolyte comprising water and an electrolyte,
an anode active material layer comprising an anode active material, and
an anode current collector,
wherein a charge potential of the anode active material calculated from a current value of a reduction peak observed by cyclic voltammetry measurement using the anode active material and the aqueous liquid electrolyte, is a more noble potential than a reduction decomposition potential of the aqueous liquid electrolyte on carbon, and it is a more base potential than the reduction decomposition potential of the aqueous liquid electrolyte on the anode current collector,
wherein the anode active material comprises a titanium oxide, and
wherein the anode active material comprises a carbon coating layer on a surface thereof.

2. The aqueous lithium ion secondary battery according to claim 1, wherein a pH of the aqueous liquid electrolyte is 3 or more and 11 or less.

3. The aqueous lithium ion secondary battery according to claim 1, wherein the electrolyte is lithium bis(trifluoromethanesulfonyl)imide.

4. The aqueous lithium ion secondary battery according to claim 1, wherein the anode current collector is at least one material selected from the group consisting of Al, Zn, Sn, Ni, SUS and Cu.

5. The aqueous lithium ion secondary battery according to claim 1, wherein the titanium oxide is at least one compound selected from the group consisting of Li₄Ti₅O₁₂ and TiO₂.
